(19) United States
(12) Patent Application Publication
(10) Pub. No.: US 2023/0337222 A1
(43) Pub. Date: Oct. 19, 2023

(54) COMMUNICATION DEVICE, COMMUNICATION METHOD, AND COMMUNICATION PROGRAM PRODUCT

(71) Applicants: DENSO CORPORATION, Kariya-city (JP); TOYOTA JIDOSHA KABUSHIKI KAISHA, Toyota-shi (JP)

(72) Inventor: Takahiro FURUYAMA, Kariya-city (JP)

(21) Appl. No.: 18/338,911

(22) Filed: Jun. 21, 2023

Related U.S. Application Data
(63) Continuation of application No. PCT/JP2021/035792, filed on Sep. 29, 2021.

(30) Foreign Application Priority Data
Dec. 24, 2020 (JP) 2020-215774

(51) Int. Cl. H04W 72/1263; H04W 72/25

(52) U.S. Cl. CPC H04W 72/1263; H04W 72/25

(57) ABSTRACT

A communication device mounted to a vehicle acquires an estimated result of a communication resource available in future for a wireless communication between the communication device and a peripheral communication device. The communication device further determines, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points. Then, the communication device transmits, to the peripheral communication device, (i) resource pattern information indicating the resource pattern and (ii) transmission target data at the time points indicated by the resource pattern using the corresponding frequencies.

### CROSS REFERENCE TO RELATED APPLICATIONS

The present application is a continuation application of International Patent Application No. PCT/JP2021/035792 filed on Sep. 29, 2021, which designated the U.S. and claims the benefit of priority from Japanese Patent Application No. 2020-215774 filed on Dec. 24, 2020. The entire disclosures of all of the above applications are incorporated herein by reference.

### TECHNICAL FIELD

The present disclosure relates to a communication device that performs wireless communication, and mainly relates to a communication device mounted on a vehicle, a method implemented by the communication device, and a program executable by the communication device.

### BACKGROUND

As wireless communication becomes widespread, opportunities to perform communication using wireless communication in various places are increasing. In particular, with the development of a technology for performing driving support and automated driving control, a moving object such as a vehicle is connected with another device in a communicable manner, which is also known as a connected vehicle. Such connected vehicles are also increasing.

### SUMMARY

The present disclosure provides a communication device, which is mounted to a vehicle. The communication device acquires an estimated result of a communication resource available in future for a wireless communication between the communication device and a peripheral communication device. The communication device further determines, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points. Then, the communication device transmits, to the peripheral communication device, (i) resource pattern information indicating the resource pattern and (ii) transmission target data at the time points indicated by the resource pattern using the corresponding frequencies.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a mobile communication system;

FIG. 2 is a diagram illustrating a mobile communication system including a communication device according to each embodiment;

FIG. 3 is a block diagram illustrating a configuration example of a communication device according to first and second embodiments;

FIG. 4A and FIG. 4B are diagrams illustrating a resource pattern determined by a resource pattern determining unit according to the first and second embodiments;

FIG. 5 is a flowchart illustrating an operation of the communication device according to the first and second embodiments;

FIG. 6A and FIG. 6B each is a diagram illustrating a resource pattern according to a first modification of the first embodiment;

FIG. 7A and FIG. 7B each is a diagram illustrating a resource pattern according to a second modification of the first embodiment;

FIG. 8 is a diagram illustrating SCI transmitted by the communication device according to the second embodiment; and

FIG. 9 is a diagram illustrating SCI transmitted by the communication device according to the second embodiment.

### DETAILED DESCRIPTION

Various communication methods may be used in V2X communication performed between a vehicle and another device. Generally, V2X communication may be performed using a communication method that performs communication via a base station, or V2X communication may be performed using a sidelink method in which adjacent communication devices directly perform communication with one another without a base station. In the sidelink method, communication can be performed even when the vehicle is located outside a coverage range of the base station or when the base station cannot be used due to a disaster or the like. Thus, a demand for communication using the sidelink method is increasing.

In a communication using the sidelink method, each communication device schedules communication resources to be used for the wireless communication using autonomous decentralized control. For example, a resource may be autonomously selected by sensing, and resource reservation information may be notified to a peripheral terminal device in order to secure the selected resource. In this configuration, by notifying the peripheral terminal device of the resource reservation information, the peripheral terminal device that has received the notification can determine that the resource reservation is made.

The inventor of the present disclosure has found the following difficulty as a result of detailed study. In the above-described configuration, after the communication devices selects one communication resource, the selected communication resource is repeatedly used until a trigger condition for reselection of another resource is satisfied. Since a communication state in a mobile communication system changes according to a position change of a moving object or time, when the same resource is repeatedly used, it becomes difficult to cope with such change of communication state. As a result, repeated use of the same resource may fail to secure an efficient communication resource, and may cause a delay or interruption in communication.

According to an aspect of the present disclosure, a communication device, which is mounted to a moving object, includes: an estimated resource acquiring unit acquiring an estimated result of a communication resource available in future for a wireless communication between the communication device and a peripheral communication device; a resource pattern determining unit determining, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points; and a communication unit transmitting, to the peripheral communication device, (i) resource pattern information indicating the resource pattern and (ii) transmission target data at the time points indicated by the resource pattern using the corresponding frequencies.

According to another aspect of the present disclosure, a communication method is executed by a communication device mounted to a moving object. The communication method includes: acquiring an estimated result of a communication resource available in future for a wireless communication between the communication device and a peripheral communication device; determining, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points; transmitting, to the peripheral communication device, resource pattern information indicating the resource pattern; and transmitting, to the peripheral communication device, transmission target data at the time points indicated by the resource pattern using the corresponding frequencies.

According to another aspect of the present disclosure, a communication program product is stored in a computer-readable non-transitory storage medium. The communication program product includes instructions to be executed by at least one processor of a communication device for performing a wireless communication. The instructions include: acquiring an estimated result of a communication resource available in future for a wireless communication between the communication device and a peripheral communication device; determining, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points; transmitting, to the peripheral communication device, resource pattern information indicating the resource pattern; and transmitting, to the peripheral communication device, transmission target data at the time points indicated by the resource pattern using the corresponding frequencies.

With the above-described configurations, it is possible to reserve, using the resource pattern, the communication resource to be used in future. The resource pattern includes multiple combinations of time points and frequencies corresponding to the time points.

The following will describe embodiments of the present disclosure with reference to the drawings.

Effects described in the following embodiments are effects obtained by a configuration of the corresponding embodiment as an example of the present disclosure, and are not necessarily effects of the present disclosure.

In the present disclosure, the configuration disclosed in each embodiment is not limited to each embodiment alone, but may be combined across the embodiments. For example, a configuration disclosed in one embodiment may be combined with other embodiments. Further, the disclosed configurations may be collected and combined in each of multiple embodiments.

The difficulty described in the present disclosure is not a publicly known issue, but persons including the inventor have independently found out, and is a fact that affirms the inventive step of the present disclosure together with the configuration and method of the present disclosure.

1. Mobile Communication System Common to All Embodiments

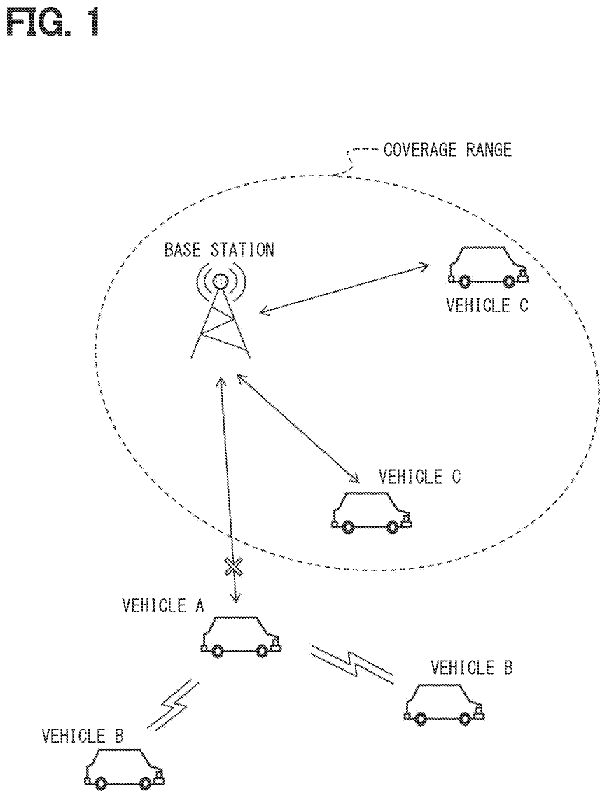

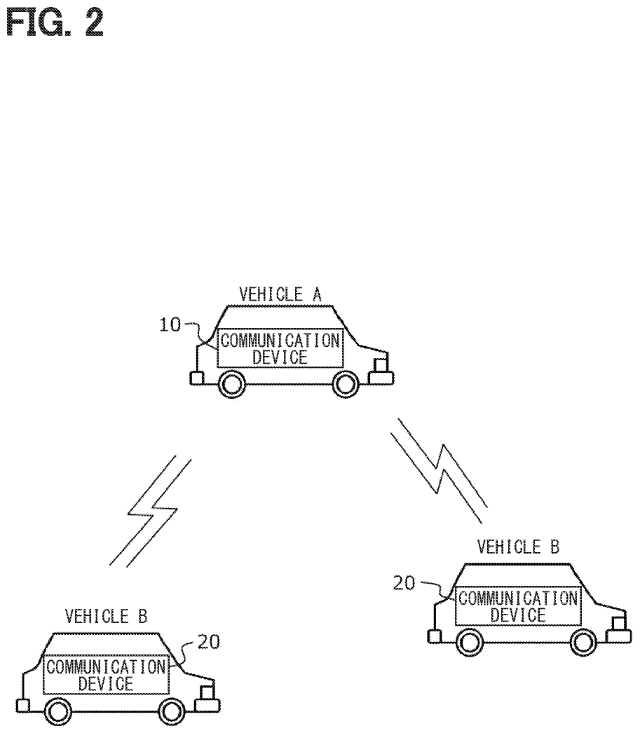

The following will describe a mobile communication system including a communication device according to each embodiment with reference to FIG. 1 and FIG. 2.

As illustrated in FIG. 1, a vehicle C located within a coverage range of a base station (for example, eNB) performs wireless communication via the base station. However, since a vehicle located outside the coverage range of the base station, such as a vehicle A and a vehicle B cannot perform wireless communication via the base station, the vehicle A and the vehicle B perform direct communication without using the base station.

FIG. 2 shows the vehicle A and the vehicle B, which are shown in FIG. 1. A communication device 10 is an onboard device, and is mounted on a vehicle A, which corresponds to a moving object. The communication device 10 performs wireless communication with a communication device 20 mounted on a vehicle B located around the vehicle A. Hereinafter, the communication device 20 is also referred to as a peripheral communication device.

The moving object is an object that is able to move, and a moving speed of the moving object may be arbitrary. The moving speed also includes a speed of zero in which the moving object is in stationary state. For example, the moving object may include, but is not limited to, vehicles, motorcycles, bicycles, pedestrians, ships, aircrafts, and objects mounted on these.

The term “mounted” includes not only a case where an object is directly fixed to the moving object but also a case where an object moves together with the moving object although the object is not fixed to the moving object. For example, the term “mount” also includes a case where a person who is on board carries the moving object, or a case where being mounted on a luggage loaded on the moving object.

The wireless communication method between the communication device 10 and the peripheral communication device 20 may adopt, for example, 5G, 4G, IEEE 802.11 (Wi-Fi (registered trademark)), IEEE 802.16 (WiMAX (registered trademark)), LTE (Long Term Evolution), LTE-A (Long Term Evolution Advanced), or the like. The wireless communication method between the communication device 10 and the peripheral communication device 20 may also adopt DSRC (Dedicated Short Range Communication).

FIG. 1 and FIG. 2 illustrate an example in which the communication device 10 is an in-vehicle device mounted on a vehicle. The communication device 10 is not limited to an in-vehicle device as long as it is mounted on the moving body. The peripheral communication device 20 that performs wireless communication with the communication device 10 may be a device other than a communication device mounted on another vehicle or another moving object. For example, the peripheral communication device 20 may be a communication device installed in a roadside device.

As described above, it is assumed that the communication device 10 is located outside the coverage range of the base station. However, each embodiment described below may also be applied to the communication device 10 located within the coverage range of the base station. In this case, the communication device 10 located within the coverage range directly communicates with the peripheral communication device 20 without using the base station while using information transmitted from the base station.

### 2. First Embodiment

(1) Configuration of Communication Device

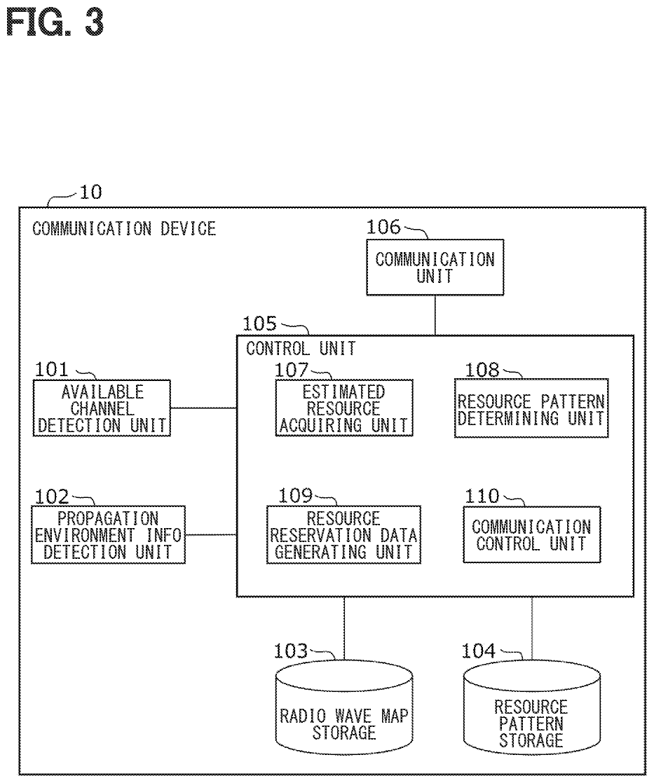

The following will describe a configuration of the communication device 10 according to the present embodiment with reference to FIG. 3.

The communication device 10 includes an available channel detection unit 101, a propagation environment information detection unit 102, a radio wave map storage 103, a resource pattern storage 104, a control unit 105, and a communication unit 106. The control unit 105 implements an estimated resource acquiring unit 107, a resource pattern determining unit 108, a resource reservation data generating unit 109, and a communication control unit 110.

The communication device 10 may include a general-purpose central processing unit (CPU), a volatile memory such as a RAM, a non-volatile memory such as a ROM, a flash memory, or a hard disk, various interfaces, and an internal bus connecting these components with one another. Then, by executing software on the hardware, the communication device can be configured to execute the function described in each functional block as shown in FIG. 3. Alternatively, the communication device may be implemented by a dedicated hardware circuit, such as a large-scale integration (LSI).

The communication device 10 may be implemented by a semi-finished product, such as an electronic control device, which is also known as an electronic control unit (ECU) in the present embodiment. The present disclosure is not limited to this configuration. For example, as a component, the communication device 10 may be implemented by a semiconductor circuit or a semiconductor module. As a finished product, the communication device 10 may be implemented by a personal computer (PC), a smartphone, a mobile phone, or a navigation system. The communication device 10 may be implemented by a single ECU or by multiple ECUs. For example, the communication device 10 may be implemented by a communication ECU that performs communication with external devices.

The available channel detection unit 101 detects a frequency band that is not used by the peripheral communication device 20. For example, the available channel detection unit 101 monitors a transmission signal transmitted from the peripheral communication device 20 to detect a frequency band that is not used by the transmission signal. Upon detecting a frequency band that is not used by the peripheral communication device 20, the available channel detection unit 101 outputs frequency band information indicating the detected frequency band to the estimated resource acquiring unit 107.

The propagation environment information detection unit 102 detects propagation environment information of a radio wave propagation path used by the communication device 10 in the wireless communication. For example, as the propagation environment information, the propagation environment information detection unit 102 detects a radio wave intensity of a reference signal received by the communication unit 106 using a device that measures the radio wave intensity of the reference signal. For example, the propagation environment information detection unit 102 detects, as the propagation environment information of the radio wave propagation path received signal strength indication (RSSI), reference signal received power (RSRP), reference signal received quality (RSRQ), signal-to-noise ratio (SNR), signal-to-interference ratio (SIR), bit error rate (BER), propagation function, propagation path matrix, and an average bit rate (bits/s) per unit time, and outputs the detected propagation environment information to the estimated resource acquiring unit 107.

The radio wave map storage 103 stores a radio wave map in which position information is mapped with propagation environment information such as a radio wave intensity at each position. For example, when the communication device 10 is located within the coverage range of the base station, the communication device transmits, to a server device, a scheduled traveling route along which the vehicle is scheduled to travel in future via the base station, and receives a radio wave map corresponding to the scheduled traveling route from the server device. The, the communication device 10 stores the received radio wave map in the radio wave map storage 103. The radio wave map storage 103 outputs the stored radio wave map to the estimated resource acquiring unit 107.

The resource pattern storage 104 stores frequencies and time points indicated by a resource pattern, which is determined by the resource pattern determining unit 108, and also stores a period of wireless communication to be performed using the resource pattern.

The control unit 105 controls operations of the available channel detection unit 101, the propagation environment information detection unit 102, the radio wave map storage 103, the resource pattern storage 104, and the communication unit 106. The control unit 105 implements the estimated resource acquiring unit 107, the resource pattern determining unit 108, the resource reservation data generating unit 109, and the communication control unit 110.

The estimated resource acquiring unit 107 estimates a communication resource that is available in future for the wireless communication between the communication device 10 and the peripheral communication device 20, and acquires the estimated result of communication resource. The estimated resource acquiring unit 107 estimates the available communication based on frequency band information output from the available channel detection unit 101, the propagation environment information output from the propagation environment information detection unit 102, or the radio wave map output from the radio wave map storage 103.

The communication resource includes a spreading code, an orthogonal frequency-division multiplexing (OFDM) channel, a beam direction, and the like in addition to the frequency and time point.

The acquiring of estimated result includes acquiring of result estimated by the estimated resource acquiring unit itself, and also includes receiving estimated result by wired communication or wireless communication from another device.

For example, a frequency band that is not currently used by the peripheral communication device 20 may not be used when the communication device 10 performs wireless communication with the peripheral communication device 20 in future. Thus, the estimated resource acquiring unit 107 estimates that the frequency band indicated by the frequency band information acquired from the available channel detection unit 101 is an available frequency band in future, that is, an available communication resource, and acquires the estimated result.

The estimated resource acquiring unit 107 may estimate a communication resource available in future by using the propagation environment information detected by the propagation environment information detection unit 102 or the radio wave map stored in the radio wave map storage 103.

For example, when the vehicle on which the communication device 10 is mounted includes a front antenna mounted to a front portion of the vehicle and a rear antenna mounted to a rear portion of the vehicle, the propagation environment information detection unit 102 detects propagation environment information of a reference signal received by the front antenna, and the estimated resource acquiring unit 107 receives the propagation environment information. It can be estimated that the propagation environment information related to the front antenna, which is detected by the propagation environment information detection unit 102, is equal to the propagation environment information obtained when the rear antenna performs wireless communication at the same position as the front antenna and the propagation environment information related to the rear antenna is detected by the propagation environment information detection unit 102. Thus, the estimated resource acquiring unit 107 estimates, as the communication resource available in future, the communication resource that can provide proper propagation environment for the wireless communication to be performed by the rear antenna with the peripheral communication device 20, using the propagation environment information detected by the front antenna. For example, the estimated resource acquiring unit 107 specifies a frequency and a position, which can provide a high radio wave intensity, and estimates a time point at which the rear antenna passes through the position. Accordingly, the estimated resource acquiring unit 107 can acquire, as the estimated result of the communication resource, the frequency and time point that can be used in future in the wireless communication with the peripheral communication device 20.

The radio wave map storage 103 stores the radio wave map, and the position information is mapped with the propagation environment information, such as the radio wave intensity at each position in the radio wave map. Upon receiving the radio wave map from the radio wave map storage 103, the estimated resource acquiring unit 107 estimates the communication resource available in future using the propagation environment information at each position of the radio wave map corresponding to the scheduled traveling route along which the vehicle travels in future. For example, the estimated resource acquiring unit 107 may specify a frequency and a position where a high radio wave intensity can be obtained, and estimates a time point at which the vehicle passes through the specified position. Accordingly, the estimated resource acquiring unit 107 can acquire, as the estimated result of the communication resource, the frequency and time point that can be used in future in the wireless communication with the peripheral communication device 20.

In the present disclosure, three kinds of methods have been described as examples of method by which the estimated resource acquiring unit 107 estimates the communication resource available in future. However, the above-described methods are merely examples and the present disclosure is not limited thereto. The estimated resource acquiring unit 107 may estimate a communication resource available in future by using a method different from the above-described methods. For example, the estimated resource acquiring unit 107 may estimate a communication resource available in future by comprehensively determining information acquired from the available channel detection unit 101, information acquired from the propagation environment information detection unit 102, and information acquired from the radio wave map storage 103.

In the present disclosure, as described above, the estimated resource acquiring unit 107 estimates, by itself, the communication resource available in future for the wireless communication with the peripheral communication device 20, and acquires the estimated result. Alternatively, the estimated resource acquiring unit 107 may acquire an estimated result by receiving a communication resource estimated by another function without estimating the communication resource available in future by itself.

The timing at which the estimated resource acquiring unit 107 acquires the estimated result of communication resource available in future may be appropriately set. For example, the estimated resource acquiring unit 107 may acquire the estimated result of communication resource available in future at a timing when a period of wireless communication using the resource pattern determined by the resource pattern determining unit 108 is ended. Alternatively, the estimated resource acquiring unit 107 may continuously acquire the estimated result of the communication resource available in future. In this case, the resource pattern determining unit 108, which will be described later, determines the resource pattern based on the latest estimated result, which is acquired when the period of wireless communication using the resource pattern is ended.

The resource pattern determining unit 108 determines the resource pattern to be used by the communication device 10 for performing the wireless communication with the peripheral communication device 20 based on the estimated result of the communication resource acquired by the estimated resource acquiring unit 107. The resource pattern includes multiple combinations of frequency at which the wireless communication is to be performed and a future time point at which the wireless communication is to be performed using the corresponding frequency.

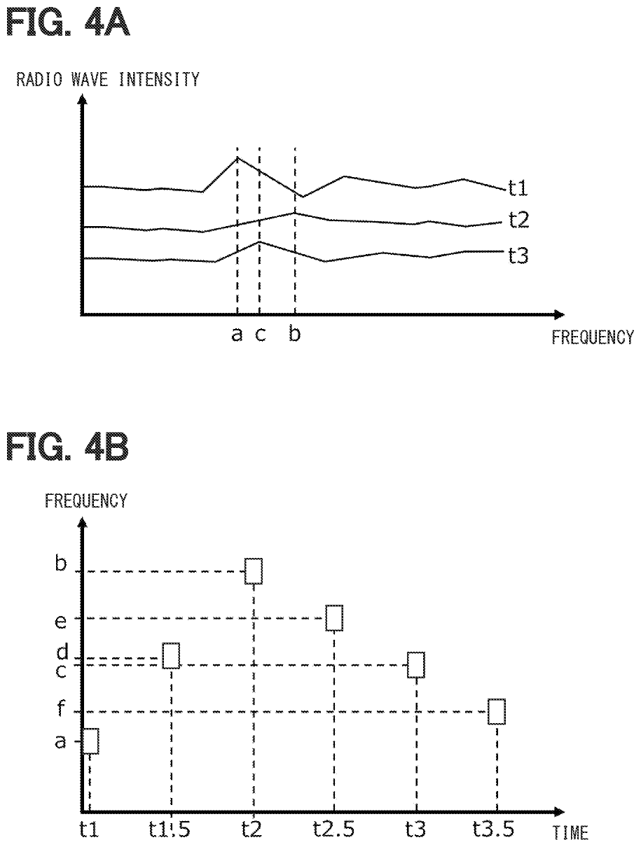

FIG. 4A and FIG. 4B are diagrams illustrating the resource pattern determined by the resource pattern determining unit 108. FIG. 4A shows a relationship between the frequency and the radio wave intensity at each future time point (t1 to t3) as an example of the propagation environment information detected by the propagation environment information detection unit 102. FIG. 4B shows the resource pattern determined by the resource pattern determining unit 108 based on the communication resource estimated using the propagation environment information illustrated in FIG. 4A.

According to FIG. 4A, the highest radio wave intensity of frequency a occurs at the time point t1, the highest radio wave intensity of frequency b occurs at the time point t2, and the highest radio wave intensity of frequency c occurs at the time point t3. Thus, the wireless communication can be efficiently performed by using the frequencies a, b, and c at the time points t1, t2, and t3, respectively. Thus, at the time point t1, the estimated resource acquiring unit 107 estimates the frequency a as the communication resource available in future. At the time point t2, the estimated resource acquiring unit 107 estimates the frequency b as the communication resource available in future. At the time point t3, the estimated resource acquiring unit 107 estimates the frequency c as the communication resource available in future.

At a time point between the time point t1 and the time point t2, it is estimated that there is a possibility that high radio wave intensity may be obtained at an intermediate frequency between the frequency a and the frequency b. Similarly, at a time point between the time point t2 and the time point t3, it is estimated that there is a possibility that high radio wave intensity may be obtained at an intermediate frequency between the frequency b and the frequency c. Thus, the estimated resource acquiring unit 107 estimates an intermediate frequency d between the frequency a and the frequency b at a time point (t1.5) between the time point t1 and the time point t2 as the communication resource available in future. Similarly, the estimated resource acquiring unit 107 estimates an intermediate frequency e between the frequency b and the frequency c at a time point (t2.5) between the time point t2 and the time point t3 as the communication resource available in future. The estimated resource acquiring unit 107 further estimates, as a communication resource available in future, a frequency f at a time point t3.5 changed from the frequency c at the time point t3 to have the same changing rate as the changing rate from the frequency e at the time point t2.5 to the frequency c at the time point t3.

FIG. 4B shows the resource pattern determined by the resource pattern determining unit 108 based on the estimated result of the communication resource available in future, which is acquired by the estimated resource acquiring unit 107. As shown in FIG. 4B, the resource pattern determining unit 108 determines, as the resource pattern, multiple combinations of frequencies (a, b, c, d, e, f) and future time points (t1, t1.5, t2, t2.5, t3, t3.5) at which the wireless communication is to be performed using the corresponding frequencies.

The resource pattern determining unit 108 further determines a period of the wireless communication to be performed using the time point and the frequency indicated by the resource pattern. In the example shown in FIG. 4B, the wireless communication is to be performed using the time points and the frequencies indicated by the resource pattern for a period from the time point t1 to the time point t3.5. Thus, the resource pattern determining unit 108 determines that the period of wireless communication to be performed using the resource pattern is from the start time point t1 to the end time point t3.5.

The value determined by the resource pattern determining unit 108 as the period of wireless communication to be performed using the resource pattern may not be necessarily set as a period from the start time point to the end time point of the wireless communication to be performed using the resource pattern. Alternatively, information capable of specifying the period, for example, the end time point (t3.5) of the wireless communication using the resource pattern or a length of time (t3.5-t1) of the wireless communication using the resource pattern may be determined as the period of wireless communication to be performed using the resource pattern. Alternatively, the number of times of performing the wireless communication may be determined by each combination of the time point and the frequency indicated by the resource pattern. For example, since the resource pattern illustrated in FIG. 4B includes six combinations of time points and frequencies, the number of times of performing the wireless communication is six times, and the number of times of performing the wireless communication (six times) may be determined as the period of wireless communication to be performed using the resource pattern.

In another example, the number of times of performing the wireless communication may be counted using a decrement counter. In such a case, a counter value corresponding to the last wireless communication using the resource pattern may be determined as the period of wireless communication to be performed using the resource pattern. In the example of FIG. 4B, when the counter value corresponding to the time point t1 is set as 6, the counter value corresponding to the time point t3.5 is set as 0. Thus, the counter value of 0 may be determined as the period of wireless communication to be performed using the resource pattern.

The resource reservation data generating unit 109 generates resource reservation data to include resource pattern information indicating the resource pattern. The resource reservation data generating unit 109 may generate, for example, resource reservation data including values of multiple frequencies and values of multiple time points as the resource pattern information. Alternatively, the resource reservation data generating unit 109 may generate the resource reservation data to include a relative value relative to a preset reference value of frequency and a time interval of the wireless communication to be performed. Alternatively, the resource reservation data generating unit 109 may generate the resource reservation data to include, in addition to the resource pattern information, communication period information indicating a period of wireless communication to be performed using the resource pattern.

The term “indicate” includes a case of direct indication and a case of indirect indication. The resource pattern information may be information that directly indicates the resource pattern using multiple frequencies and multiple time points, or the resource pattern information may be information that indirectly indicates the resource pattern using identification information allocated to the resource pattern. The communication period information may be information that directly indicates the communication period, or may be information that indirectly indicates the communication period using the end time point of the wireless communication using the resource pattern.

The communication control unit 110 controls the wireless communication performed by the communication unit 106. Specifically, the communication control unit 110 controls the communication unit 106 to transmit transmission target data, which is acquired by the vehicle, to the peripheral communication device 20 at the frequency and the time point indicated by the resource pattern determined by the resource pattern determining unit 108.

The communication unit 106 transmits, to the peripheral communication device 20, the resource reservation data including the resource pattern information. The communication unit 106 also transmits, to the peripheral communication device 20, the transmission target data, which is acquired by the vehicle, at the time point indicated by the resource pattern using the frequency corresponding to the time point. The following will describe functions of the communication unit 106 for each type of data transmitted by the communication unit 106.

In the above description, the term “together” is not limited to concurrent transmission of the resource reservation data and the transmission target data. The term “together” indicates that the communication unit performs both of the transmission process of resource pattern information and the wireless communication process with the peripheral communication device.

In the above description, the term “transmit” includes a case where the communication device directly transmits data to the peripheral communication device, and also includes a case where the communication device indirectly transmits data to the peripheral communication device via another device, which has a communication function, by transmitting the data to another device.

First, the communication unit 106 broadcasts, to the peripheral communication device 20, the resource reservation data, which is generated by the resource reservation data generating unit 109 to include the resource pattern information and the communication period. As described above, the resource pattern information indicates the resource pattern to be used in future by the communication device 10. Thus, when the peripheral communication device 20 receives the resource pattern information, the peripheral communication device 20 can determine that when the peripheral communication device 20 performs a communication using the combination of the frequency and the time point indicated by the resource pattern information, the communication resource will have a collision with the communication resource used by the communication device 10. Thus, the peripheral communication device avoids a wireless communication using the combination of the frequency and the time point indicated by the resource pattern information. That is, when the communication unit 106 transmits the resource reservation data including the resource pattern information, the communication resource of the frequency and the time point indicated by the resource pattern information is reserved as a result.

Second, the communication unit 106 transmits the transmission target data to the peripheral communication device 20 at the time point indicated by the resource pattern using the frequency corresponding to the time point. When the transmission target data is transmitted to the peripheral communication device 20, the transmission target data may be transmitted to a specific peripheral communication device 20 in unicast manner, or may be transmitted in broadcast manner similarly to the resource reservation data. Examples of the transmission target data include image data captured by a vehicle-mounted camera mounted on the vehicle, sensor data detected by vehicle-mounted sensors, and position data of the vehicle.

When the communication device 10 is configured as an electronic control unit (ECU), the communication unit 106 functions as a wireless communication device and directly transmits the resource reservation data and the transmission target data to the peripheral communication device 20. When the communication device 10 is configured as a semiconductor circuit, the communication unit 106 functions as an interface of the semiconductor circuit and transmits data to a device, which has a wireless communication function and is able to communicate with the peripheral communication device 20.

In the present embodiment, the communication unit 106 transmits the resource reservation data including the resource pattern information, and also transmits the transmission target data at the time point indicated by the resource pattern using the frequency corresponding to the time point. Alternatively, the resource reservation data and the transmission target data may be transmitted by respective communication units different from one another using the same or different communication methods.

(2) Operation of Communication Device 10

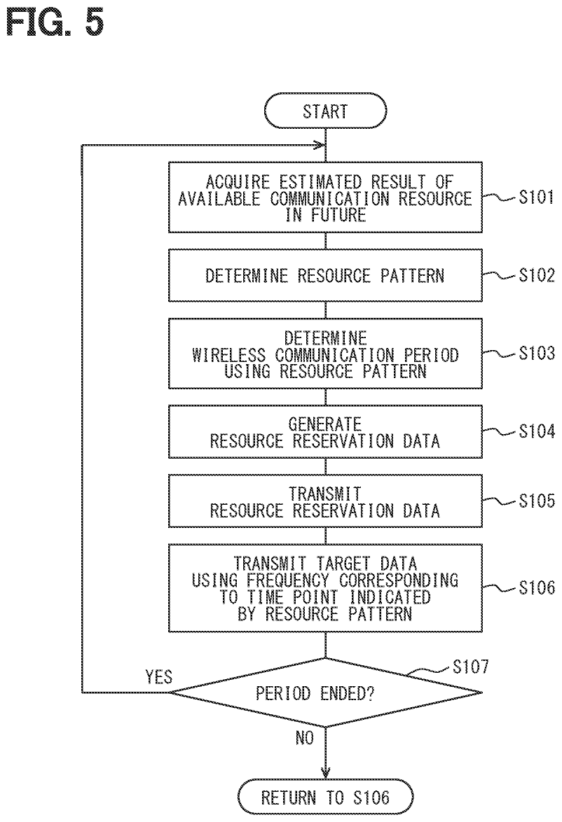

The following will describe an operation of the communication device 10 with reference to FIG. 5. Note that the following operation not only shows a communication control method executed by the communication device 10, but also shows a processing procedure of a communication program executable by the communication device 10. The process is not limited to the execution order illustrated in FIG. 5 That is, the order may be properly changed as long as there is no restriction such as a relationship in which a result of a previous step is used in a subsequent step.

In S101, the estimated resource acquiring unit 107 acquires the estimated result of communication resource that can be used by the communication device 10 in future for the wireless communication with the peripheral communication device 20.

In S102, the resource pattern determining unit 108 determines the resource pattern based on the estimated result of communication resource acquired in S101.

In S103, the resource pattern determining unit 108 further determines the period of wireless communication to be performed using the resource pattern.

In S104, the resource reservation data generating unit 109 generates the resource reservation data including the resource pattern information indicating the resource pattern determined in S102 and the communication period information indicating the communication period determined in S103.

In S105, the communication unit 106 transmits the resource reservation data generated in S104.

In S106, the communication unit 106 transmits the transmission target data at the time point indicated by the resource pattern determined in S102 using the frequency corresponding to the time point.

In S107, the communication unit determines whether the period of wireless communication using the resource pattern has ended. In response to the communication unit determining that the communication period has ended, the estimated resource acquiring unit 107 acquires the estimated result of communication resource available in future again in S101.

In response to the communication unit determining that the communication period has not ended, the communication unit 106 returns to S106 and transmits the transmission target data at the next time point indicated by the resource pattern using the corresponding frequency.

As described above, according to the present embodiment, the communication device 10 can reserve the communication resource to be used in future by using the resource pattern, which includes multiple combinations of frequencies and time points determined based on the estimated result of communication resource available in future. Accordingly, compared to a case where the same communication resource is repeatedly used, it is possible to select and reserve the communication resource capable of efficiently performing the communication, thereby improving communication efficiency of wireless communication that is performed not via the base station.

(3) First Modification

The following will describe a first modification in which the resource pattern determining unit 108 determines the resource pattern based on (i) data amount of the transmission target data scheduled to be transmitted to the peripheral communication device 20 in addition to (ii) the estimated result of communication resource available in future.

When the data amount of transmission target data to be transmitted to the peripheral communication device 20 using the resource pattern is always constant, the resource pattern determining unit 108 does not need to change a bandwidth of the frequency to be used corresponding to the transmission target data. When the data amount of transmission target data is not constant, there is a possibility that a communication delay may occur in transmission of the transmission target data having a large data amount using the constant bandwidth of frequency.

When the data amount of transmission target data is large, the wireless communication can be performed by extending the bandwidth of frequency used for wireless communication without reserving the communication resource in advance. When the communication resource is not reserved in advance, there is a possibility that the peripheral communication device 20 may perform the wireless communication using a frequency that overlaps with the extended frequency used by the communication device 10. As a result, there is a possibility that the communication resources of communication devices 10, 20 collide with one another, and accordingly the communication quality deteriorates. Thus, it is desirable to reserve the communication resource to be used in future by determining the bandwidth of frequency according to the data amount of transmission target data, and transmits the resource pattern information indicating the appropriate bandwidth of frequency to the peripheral communication device 20.

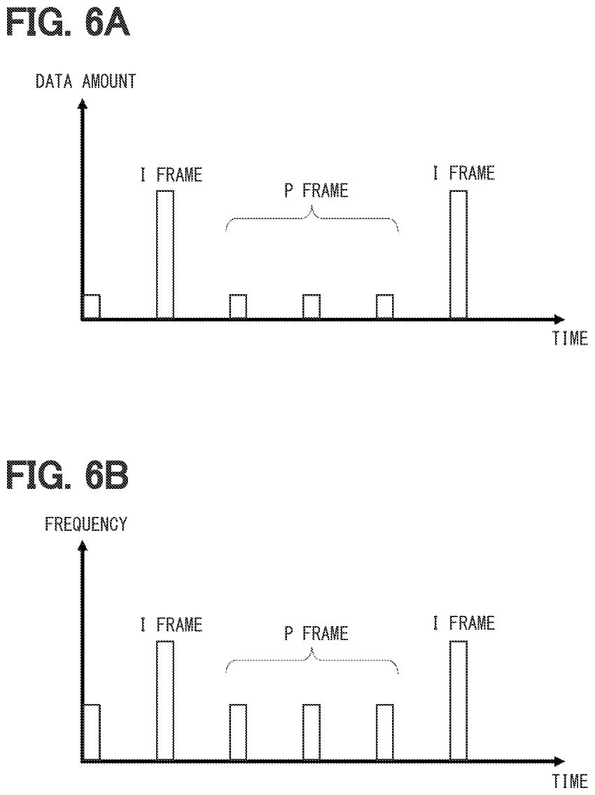

FIG. 6 is a diagram illustrating a resource pattern in a case where the data amount changes over time. In image compression techniques, such as H.264 and H.265, image information is generated using inter-frame prediction in which a moving image captured by a camera or the like is compressed by encoding a difference between images (frames) that change over time, or image information is generated using intra-frame prediction in which an image is compressed within the same frame. The image information includes an I frame encoded without using the inter-frame prediction, a P frame encoded using only forward prediction in terms of time, and the like.

In the I frame, compression by inter-frame prediction is not performed, and only the compression by intra-frame prediction is performed. Thus, as illustrated in FIG. 6A, the data amount is larger than the data amount of P frame in which compression is performed using the inter-frame prediction. Thus, when the bandwidth of frequency used to transmit the I frame is set to be the same as the bandwidth of frequency used to transmit the P frame, the communication resource may be insufficient for the transmission of the I frame, and the communication delay may occur. Thus, as illustrated in FIG. 6B, in a transmission of the I frame having large amount of data, the resource pattern determining unit 108 may determine the resource pattern so that the bandwidth of frequency set for the I frame is wider than the bandwidth of frequency set for the P frame. In order to compare the bandwidth of frequency for transmitting the I frame with the bandwidth of frequency for transmitting the P frame, FIG. 6B illustrates an example in which the transmission target data is transmitted using the overlapping frequency. However, the resource pattern determining unit 108 can appropriately determine the frequency used to transmit the data based on the estimated result of communication resource available in future.

According to the present modification, it is possible to select and reserve the communication resource necessary for transmitting the transmission target data to the peripheral communication device 20 according to the data amount of the transmission target data scheduled to be transmitted in future. According to the present modification, it is also possible to prevent an occurrence of communication delay or communication interruption due to shortage of the reserved communication resource, or the use of the unreserved communication resource when transmitting the transmission target data.

(4) Second Modification

In the above-described first embodiment, the time point and the corresponding frequency indicated by the resource pattern are included in the resource reservation data as the resource pattern information, and are transmitted to the peripheral communication device 20. In the present modification, identification information for specifying the resource pattern is included in the resource reservation data and transmitted as the resource pattern information.

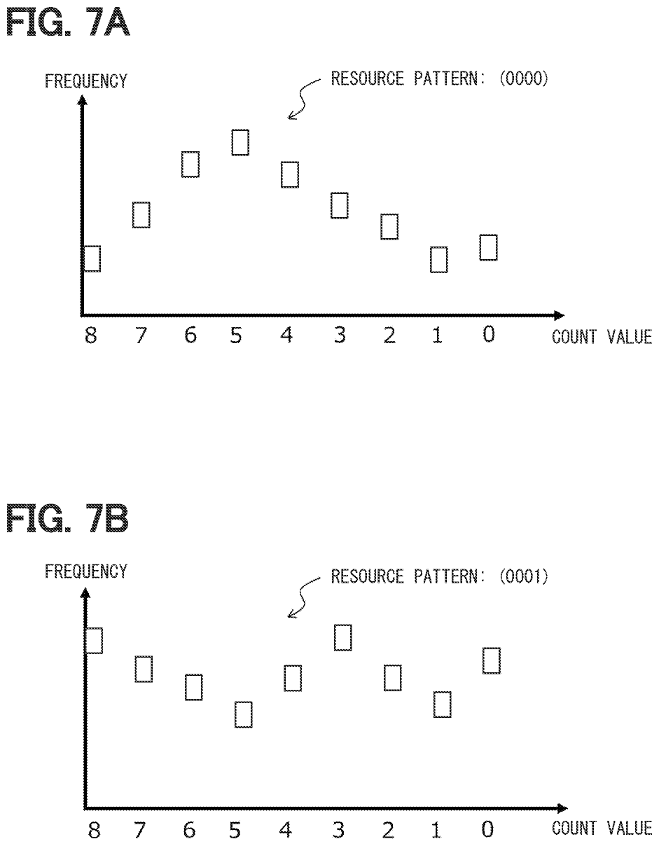

FIGS. 7A and 7B illustrate two different resource patterns, respectively. In the configuration shown in FIG. 7A and FIG. 7B, unlike the configuration shown in FIG. 4B, the number of times by which the wireless communication is to be performed is counted by a decrement counter, and the number of times of the wireless communication is used instead of the time point at which the wireless communication is performed.

Each resource pattern illustrated in FIG. 7A and FIG. 7B is assigned with identification information for specifying the resource pattern. For example, identification information of (0000) is assigned to the resource pattern illustrated in FIG. 7A, and identification information of (0001) is assigned to the resource pattern illustrated in FIG. 7B.

The resource pattern determining unit 108 of the present modification selects and determines one resource pattern from multiple resource patterns each of which is assigned with predetermined identification information based on the estimated result of communication resource available in future. For example, when an efficient wireless communication can be performed using the resource pattern shown in FIG. 7A rather than using the resource pattern shown in FIG. 7B, the resource pattern determining unit 108 selects and determines the resource pattern illustrated in FIG. 7A. Then, the resource reservation data generating unit 109 generates the resource reservation data including the identification information of (0000) as scheduled transmission information. Accordingly, it is possible to suppress the communication amount of resource reservation data compared with a case where multiple combinations of time points and frequencies are included in the resource reservation data and transmitted.

When the resource pattern information is provided by the identification information, the resource reservation data may further include identification flag information indicating that the resource pattern information is provided by the identification information for specifying the resource pattern. By including the identification information flag in the resource reservation data, the peripheral communication device 20 that has received the resource reservation data can easily determine that the information included in the resource reservation data is the identification information for specifying the resource pattern, and specify the resource pattern corresponding to the identification information.

In the present modification, the resource pattern determining unit 108 may determine information for specifying a part of the resource pattern as the communication period of wireless communication to be performed using the resource pattern. For example, in a case where the wireless communication can be performed with high efficiency at frequencies and time points corresponding to the counter value of 6 to the count value of 2 in the resource pattern illustrated in FIG. 7A, the resource pattern determining unit 108 may determine a period between the counter value of 6 and the count value of 2 as the period of wireless communication to be performed using the resource pattern.

In the present modification, it is necessary to assume multiple sets of resource patterns in advance and assign identification information to each resource pattern so that the resource pattern determining unit 108 can select one resource pattern including multiple combinations of frequencies and time points at which efficient wireless communication can be performed. As the number of resource patterns increases, the possibility that the resource pattern determining unit 108 can select a more appropriate resource pattern increases, but the information amount of the identification information for specifying the resource pattern also increases. Thus, by (i) allocating identification information to the resource pattern, which includes large number of combinations of frequencies and time points, and (ii) specifying a part of the resource pattern as the period of wireless communication to be performed using the resource pattern, the total number of identification information records for specifying the corresponding resource patterns can be reduced and data amount of identification information can be suppressed.

As described above, according to the present modification, it is possible to reduce the information amount of the resource reservation data by specifying the resource pattern using the identification information.

### 3. Second Embodiment

In the present embodiment, the communication device 10 performs the wireless communication with the peripheral communication device 20 using 5G as the wireless communication method. The 5G communication technology is also known as 5G new radio (5G-NR) in which the specification of communication is formulated by third generation partnership project (3GPP).

In the 5G communication technology, communication devices that perform wireless communication using the sidelink method transmit and receive sidelink control information (SCI) indicating scheduling information of the sidelink communication method. The SCI is information transmitted using a physical sidelink control channel (PSCCH) or a physical sidelink shared channel (PSSCH). The communication device 10 can reserve the communication resource scheduled to be used in future by transmitting the SCI to the peripheral communication device 20 using the PSCCH or using the PSSCH. The PSCCH is a channel mainly used for transmission and reception of control information for performing wireless communication by the sidelink method. The PSSCH is a channel mainly used for transmission and reception of transmission target data. When the PSSCH is used for transmission of SCI, the SCI is added to the transmission target data and transmitted.

In the present embodiment, the resource reservation data generating unit 109 shown in FIG. 3 generates the SCI as the resource reservation data. Therefore, in the present embodiment, the resource reservation data generating unit 109 will be referred to as a SCI generating unit 109.

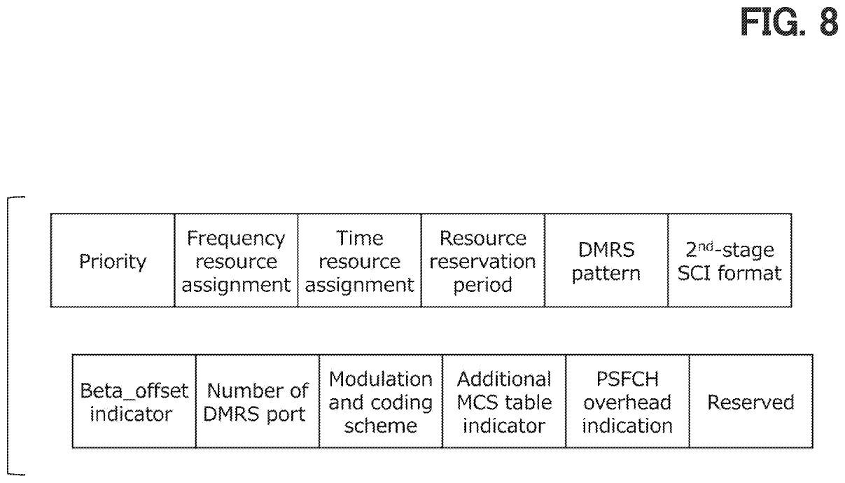

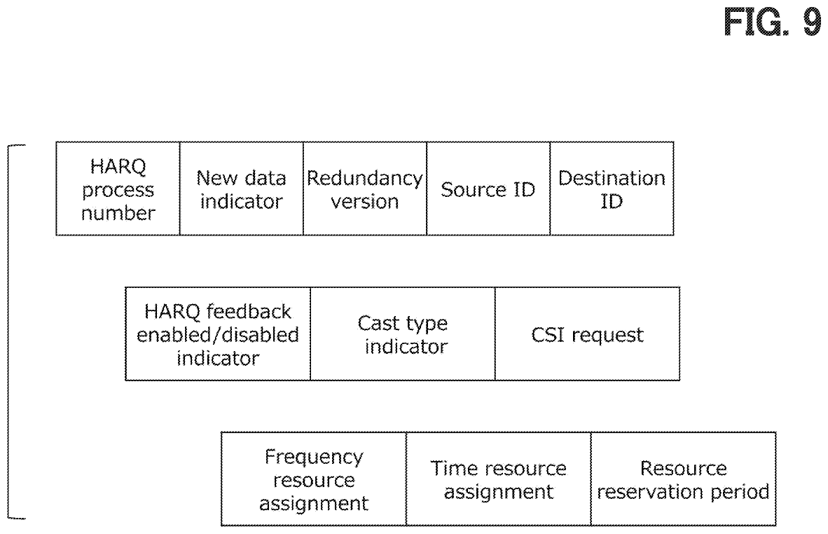

The SCI has two main types. One is a first stage SCI (1st-stage SCI) illustrated in FIG. 8, and the other is a second stage SCI (2nd-stage SCI) illustrated in FIG. 9. The following will describe a case where the resource pattern information described in the first embodiment is stored in the first stage SCI and transmitted, and a case where the resource pattern information is stored in the second stage SCI and transmitted.

(1) A Case where Resource Pattern Information is Stored in First Stage SCI

The first stage SCI is transmitted using the PSCCH. The first stage SCI mainly includes information about PSSCH. For example, the information about PSSCH may include information indicating which PSSCH resource to be used by the communication device to transmit the data. The first stage SCI has a format shown in FIG. 8, and stores data in each field.
(a) Priority
(b) Frequency resource assignment
(c) Time resource assignment
(d) Resource reservation period
(e) DMRS pattern
(f) 2nd-stage SCI format
(g) Beta_offset indicator
(h) Number of DMRS port
(i) Modulation and coding scheme
(j) Additional MCS table indicator
(k) PSFCH overhead indication
(l) Reserved

The SCI generating unit 109 generates the first stage SCI in which the resource pattern information indicating the resource pattern is stored. Specifically, as shown in FIG. 8, the SCI generating unit 109 stores, in the (b) frequency resource assignment of first stage SCI, the frequencies indicated by the resource pattern, which is determined by the resource pattern determining unit 108. Further, the SCI generating unit 109 stores, in the (c) time resource assignment of the first stage SCI, the time points at which the wireless communication is performed at corresponding frequencies indicated by the resource pattern.

The SCI generating unit 109 may further store, in the (d) resource reservation period of first stage SCI, the communication period information indicating the period during which the wireless communication is performed using the resource pattern.

When the resource pattern information is provided by the identification information for specifying the resource pattern, the identification information is stored only in the (b) frequency resource assignment or only in the (c) time resource assignment of the first stage SCI. As another example, the identification information may be stored in both of the (b) frequency resource assignment and the (c) time resource assignment of the first stage SCI. In this case, the identification flag indicating that the resource pattern information is provided by the identification information may be stored in (I) reserved of the first stage SCI.

Then, the communication unit 106 transmits the first stage SCI generated by the SCI generating unit 109 to the peripheral communication device 20 using the PSCCH.

Since V2X communication requires high reliability and real-time performance, it is expected that 5G communication technology, which enables large data capacity communication and high speed communication compared with conventional communication technology, is used for the V2X communication. By applying the communication device according to the first embodiment to a communication device that supports 5G communication technology, in the 5G communication technology, the communication resource to be used in future can be reserved using the resource pattern, which includes multiple combinations of frequencies and time points determined based on the estimated result of communication resource available in future.

(2) A Case where Resource Pattern Information is Stored in Second Stage SCI

The second stage SCI is transmitted using the PSSCH. The second stage SCI is information added to the transmission target data and transmitted together with the transmission target data when the transmission target data is transmitted using the PSSCH. The second stage SCI has a format shown in FIG. 9, and stores data in each field.
(a) HARQ process number
(b) New data indicator
(c) Redundancy version
(d) Source ID
(e) Destination ID
(f) HARQ feedback enabled/disabled indicator
(g) Cast type indicator
(h) CSI request
(i) Frequency resource assignment
(j) Time resource assignment
(k) Resource reservation period

The second stage SCI stores more detailed information about communication compared with the first stage SCI. For example, as shown in FIG. 9, the second stage SCI stores information about (b) new data indicator, which indicates whether transmission target data is new data or retransmission data, and also stores information about the transmission source communication device, such as the (d) source ID.

When the resource pattern information is included in the second stage SCI and to be transmitted, the SCI generating unit 109 stores, in the (i) frequency resource assignment of second stage SCI, the frequencies indicated by the resource pattern, which is determined by the resource pattern determining unit 108. Further, the SCI generating unit 109 stores, in the (j) time resource assignment of the second stage SCI, the time points at which the wireless communication is performed at corresponding frequencies indicated by the resource pattern. The second stage SCI is generated in this way. The second stage SCI corresponds to a second SCI.

Similar to the first stage SCI, the SCI generating unit 109 may further store, in the (k) resource reservation period of second stage SCI, the communication period information indicating the period during which the wireless communication is performed using the resource pattern.

The SCI generating unit 109 further stores, in (I) reserved of the above-described first stage SCI, resource reservation flag information, and generates the first stage SCI. The first stage SCI corresponds to a first SCI. The resource reservation flag information indicates that the wireless communication is to be performed using the corresponding frequency at the time point set in the resource pattern, which is indicated by the resource pattern information stored in the second stage SCI.

Then, the communication unit 106 transmits the first stage SCI to the peripheral communication device 20 using the PSCCH, and transmits the second stage SCI to the peripheral communication device 20 using the PSSCH.

As described above, since the PSCCH is a channel mainly used for transmission and reception of control information of wireless communication performed using the sidelink method, the PSCCH has fewer resources that can be allocated to transmission of the SCI compared with the resources of PSSCH used for transmission and reception of transmission target data. Thus, by storing the resource pattern information in the second stage SCI, it is possible to suppress the resource usage of the PSCCH. Furthermore, since the second stage SCI is transmitted every time the transmission target data is transmitted, it is possible to transmit more fine-grained resource pattern information compared with the first stage SCI, thereby improving control accuracy of the communication resource.

4. General Overview

The features of the communication devices according to each embodiment of the present disclosure are described above.

Terms used in the description of each embodiment are examples and may be replaced with synonymous terms or terms having a synonymous function.

In the block diagrams used to describe the embodiments, the configurations of the devices are classified and organized for each function. The blocks representing the respective functions can be implemented by any combination of hardware and software. Further, the block diagrams illustrate the functions. Thus, the block diagrams also correspond to the method and program that implement the method.

Functional blocks that can be understood as processes, flows, and methods described in the respective embodiments may be changed in order as long as there is no restrictions such as a relationship in which results of preceding other steps are used in one step.

The terms of first, second, and N-th (N is an integer) used in each embodiment and the claims are used to distinguish two or more configurations of the same type and two or more methods of the same type and do not limit the order and superiority and inferiority.

In the above-described embodiments, it is assumed that the communication device performs the wireless communication with the peripheral communication device mounted on a moving object, such as a vehicle. The present disclosure is not limited to this configuration. The communication device may perform the wireless communication with any peripheral communication device unless particularly limited by the claims.

In the present disclosure, examples of the device may include the following configurations. As an electronic component, the device may include semiconductor elements, electronic circuits, modules, microcomputers. As a semi-finished product, the device may include electronic control units (ECU) and system boards. As a completely finished product, the device may include a mobile phone, a smartphone, a tablet, a personal computer (PC), a workstation, or a server. Other examples may include devices having communication functions, such as a video camera, a still camera, or a car navigation system.

Each device may additionally include necessary functions, such as an antenna and a communication interface.

The present disclosure is implemented not only by dedicated hardware having a configuration and a function described in relation to each embodiment. The present disclosure can also be implemented as a combination of a program for implementing the present disclosure, recorded on such a recording medium as memory and a hard disk and general-purpose hardware including dedicated or general-purpose CPU, memory, or the like, capable of executing the program.

A program may be stored in a non-transitory tangible storage medium including (i) an external storage (e.g., hard disk, USB memory, CD/BD), or (ii) an internal storage (e.g., RAM, ROM) in a special-purpose or general-purpose hardware (e.g., computer). Such a program may be downloaded to the storage medium in the hardware via a communication link from a server. Consequently, as the program is upgraded, the corresponding latest function can be always provided.

### INDUSTRIAL APPLICABILITY

The communication device according to the present disclosure has been described mainly as an on-board communication device mounted on a vehicle. The communication device may also be applied to a device that communicates with moving objects, such as motorcycles, bicycles with electric motors, railways, pedestrians, ships, and aircrafts.

What is claimed is:

1. A communication device mounted to a moving object, the communication device comprising:
a memory storing a program; and
at least one processor, by executing the program stored in the memory, configured to:
acquire an estimated result of a communication resource available in future for a wireless communication between the communication device and a peripheral communication device;
determine, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points; and
transmit, to the peripheral communication device, (i) resource pattern information indicating the resource pattern and (ii) transmission target data at the time points indicated by the resource pattern using the corresponding frequencies.

2. The communication device according to claim 1, wherein
the at least one processor is further configured to:
determine a period of the wireless communication to be performed at the time points indicated by the resource pattern using the corresponding frequencies; and
transmit, to the peripheral communication device, communication period information indicating the period of the wireless communication in addition to the resource pattern information.

3. The communication device according to claim 1, wherein
the at least one processor determines the resource pattern further based on information amount of the transmission target data scheduled to be transmitted from the communication device to the peripheral communication device in future, in addition to the estimated result of the communication resource available in future.

4. The communication device according to claim 1, wherein
the resource pattern information is identification information for specifying the resource pattern, and
the at least one processor transmits, to the peripheral communication device, identification flag information indicating that the resource pattern information is the identification information, in addition to the identification information.

5. The communication device according to claim 1, wherein
the at least one processor further generates sidelink control information (SCI) to include the resource pattern information, and transmits the generated SCI to the peripheral communication device.

6. The communication device according to claim 5, wherein
the resource pattern information is identification information for specifying the resource pattern,
the SCI further includes identification flag information, which indicates that the resource pattern information is the identification information, in addition to the identification information, and
the at least one processor transmits the SCI to the peripheral communication device.

7. The communication device according to claim 5, wherein
the at least one processor transmits the SCI using a physical sidelink control channel (PSCCH).

8. The communication device according to claim 5, wherein
the at least one processor generates (i) a first SCI including resource reservation flag information and (ii) a second SCI including the resource pattern information,
the resource reservation flag information indicates that the wireless communication is scheduled to be performed at the time points indicated by the resource pattern using the corresponding frequencies, and
the at least one processor:
transmits the first SCI using a physical sidelink control channel (PSCCH); and
transmits the second SCI using a physical sidelink shared channel (PSSCH).

9. A communication method executed by a communication device mounted to a moving object, the communication method comprising:
acquiring an estimated result of a communication resource available in future for a wireless communication between the communication device and a peripheral communication device;
determining, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points;
transmitting, to the peripheral communication device, resource pattern information indicating the resource pattern; and
transmitting, to the peripheral communication device, transmission target data at the time points indicated by the resource pattern using the corresponding frequencies.

10. A communication program product stored in a computer-readable non-transitory storage medium, the communication program product comprising instructions to be executed by at least one processor of a communication device mounted to a moving object, the instructions comprising:
acquiring an estimated result of a communication resource available in future for a wireless communication between the communication device and a peripheral communication device;
determining, as a resource pattern, a plurality of combinations of frequencies and time points in future based on the estimated result of the communication resource available in future, the communication device performing the wireless communication with the peripheral communication device at the time points indicated by the resource pattern using the frequencies corresponding to the time points;
transmitting, to the peripheral communication device, resource pattern information indicating the resource pattern; and
transmitting, to the peripheral communication device, transmission target data at the time points indicated by the resource pattern using the corresponding frequencies.
